(19) United States
(12) Patent Application Publication
(10) Pub. No.: US 2017/0118108 A1
(43) Pub. Date: Apr. 27, 2017

(54) Real Time Priority Selection Engine for Improved Burst Tolerance

(71) Applicant: Futurewei Technologies, Inc., Plano, TX (US)

(72) Inventors: Serhat Nazim Avci, Sunnyvale, CA (US); Zhenjiang Li, San Jose, CA (US); Fangping Liu, San Jose, CA (US)

(21) Appl. No.: 14/923,679

(22) Filed: Oct. 27, 2015

(51) Int. Cl. H04L 12/721; H04L 12/863; H04L 12/801

(52) U.S. Cl. CPC H04L 45/36; H04L 47/12; H04L 47/50

(57) ABSTRACT

A network switch comprising a plurality of ports each comprising a plurality of queues, and a processor coupled to the plurality of ports, the processor configured to obtain a packet traveling along a path from a source to a destination, determine a reverse path port positioned along a reverse path from the destination to the source, obtain a queue occupancy counter from the packet, the queue occupancy counter indicating an aggregate congestion of queues along the reverse path, and update the queue occupancy counter with congestion data of the queues for the reverse path port.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Network customers, sometimes referred to as tenants, often employ software systems operating on virtualized resources, such as virtual machines (VMs) in a cloud environment. Virtualization of resources in a cloud environment allows virtualized portions of physical hardware to be allocated and de-allocated between tenants dynamically based on demand. Virtualization in a cloud environment allows limited and expensive hardware resources to be shared between tenants, resulting in substantially complete utilization of resources. Such virtualization further prevents over allocation of resources to a particular tenant at a particular time and prevents resulting idleness of the over-allocated resources. Dynamic allocation of virtual resources may be referred to as provisioning. The use of virtual machines further allows tenants software systems to be seamlessly moved between servers and even between different geographic locations. However, dynamic allocation can cause data to move across the networks in sudden bursts, which can strain the networks ability to effectively move data and can result in dropped packets. As another example, bursts may occur any time datacenter applications span multiple machines which need to share data with each other for the application purposes. Data bursts are a common phenomenon in data center networks.

### SUMMARY

In an embodiment, the disclosure includes a network switch comprising a plurality of ports each comprising a plurality of queues, and a processor coupled to the plurality of ports, the processor configured to obtain a packet traveling along a path from a source to a destination, determine a reverse path port positioned along a reverse path from the destination to the source, obtain a queue occupancy counter from the packet, the queue occupancy counter indicating an aggregate congestion of queues along the reverse path, and update the queue occupancy counter with congestion data of the queues for the reverse path port.

In another embodiment, the disclosure includes a method comprising receiving an incoming packet from a remote node along a path from the remote node, obtaining a queue occupancy counter from the incoming packet, the queue occupancy counter indicating aggregate congestion values for each of a plurality of priority queues along a reverse path to the remote node, and selecting an outgoing priority queue for an outgoing packet directed to the remote node along the reverse path by selecting a priority queue along the reverse path with a smallest aggregate congestion value from a group of eligible priority queues along the reverse path.

In yet another embodiment, the disclosure includes a method comprising obtaining a packet traveling along a path from a source to a destination, determining a reverse path port positioned along a reverse path from the destination to the source, obtaining a queue occupancy counter from the packet, the queue occupancy counter indicating an aggregate congestion of queues along the reverse path, and updating the queue occupancy counter with congestion data of the queues for the reverse path port.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a multilayer data center network architecture.

FIG. 2 is a schematic diagram of an embodiment of a single layer data center network architecture.

FIG. 3 is a schematic diagram of an embodiment of a packet drop due to a congested priority queue.

FIG. 4 is a schematic diagram of an embodiment of a scheme for communicating a queue occupancy counter across a network domain.

FIG. 5 is a schematic diagram of an embodiment of a network element (NE) within a network.

FIG. 6A is a schematic diagram of an embodiment of a host receiving a queue occupancy counter at a first time.

FIG. 6B is a schematic diagram of an embodiment of a host altering a priority selection at a second time based on the queue occupancy counter received at the first time.

FIG. 7 is a schematic diagram of an embodiment of a switch updating a queue occupancy counter with priority congestion values for a reverse path.

FIG. 8 is a schematic diagram of an embodiment of a mechanism for maintaining queue occupancy counters in a multilayer network by employing encapsulation.

FIG. 9 is a schematic diagram of an embodiment of a mechanism for mapping priorities to a queueing and scheduling structure of an end-host.

FIG. 10 is a flowchart of an embodiment of a method of updating a queue occupancy counter with priority congestion values for a reverse path.

FIG. 11 is a flowchart of an embodiment of a method of maintaining queue occupancy counters in a multilayer network.

FIG. 12 is a flowchart of an embodiment of a method of priority selection based on a priority matrix.

FIGS. 13-14 illustrate graphs depicting link utilization and microbursts in an embodiment of a datacenter network.

FIG. 15 illustrates a graph depicting packet loss in an embodiment of a datacenter network.

FIG. 16 is a graph of buffer occupancy change over time and granularity of the buffer occupancy levels in an embodiment of datacenter network.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Traffic engineering techniques may be employed in datacenters and other networks to route traffic around heavily used network links in order to avoid network congestion caused by traffic bursts. Such traffic engineering techniques are particularly useful when traffic bursts are expected beforehand and/or continue for a relatively long period of time. Traffic engineering techniques are much less useful for managing congestion for microbursts. A microburst is a rapid burst of data packets sent in quick succession, which can lead to periods of full line-rate transmission and can cause overflows of network element packet buffers, both in network endpoints and routers and switches inside the network. Microbursts by nature are both transitory and difficult to predict. As such, microbursts may result in large numbers of packet drops and then become resolved before traffic engineering protocols can engage to resolve the issue.

Disclosed herein is a scheme to speed detection of microbursts and allow network nodes to rapidly change packet routing mechanisms to avoid congestion. Network element ports are associated buffers/queues configured to hold packets of varying priority. Microbursts may result in part from a particular priority queue/set of priority queues becoming overloaded. Packets routed along a path through the network are configured to carry a queue occupancy counter. The queue occupancy counter comprises data indicating congestion for each queue along a reverse path through the network. When a switch/router receives a packet traversing a path, the switch/router determines local ports associated with the reverse path and updates the queue occupancy counter with congestion values for queues associated with the local ports on the reverse path. As such, the queue occupancy counter contains data indicating the aggregate congestion for each queue along the reverse path, which can indicate microbursts as they occur. A host receiving the packet employs the queue occupancy counter to update a local priority matrix. The priority matrix may be updated once per flowlet. The host checks the local priority matrix when sending a packet along the reverse path. If a priority queue for a packet is congested, the host can select a different priority queue to mitigate the congestion and avoid packet drops. For example, the host may remove from consideration any priorities employing a different scheduling scheme, remove from consideration any reserved priorities, merge eligible priorities associated with a common traffic class, and select an eligible traffic class with the lowest congestion along the reverse path. A multilayer network architecture may complicate matters as a multilayer network architecture may employ multiple paths between each host. In a multilayer network architecture, each switch/router positioned along a decision point employs a priority matrix. The switch/router maintains the queue occupancy counter for the lower layer, selects a best path based on the priority matrix, and encapsulates the packet with an upper layer header and an upper layer queue occupancy counter for the upper layer. The upper layer header with the upper layer queue occupancy counter can be removed when the packet reaches a corresponding switch/router at the edge for the upper layer and the lower layer. As such, the host need only maintain awareness of the queue congestion occurring in the path to/from the upper layer and the upper layer switches that select the path through the upper layer can maintain awareness of queue congestion along the available upper layer paths and change priority as needed. It should be noted that in certain multilayer architectures the reverse path is consistently selected to be the same as the forward path rendering path selection predictable by the end-hosts. In such a case a single layer queue counters are sufficient. Multi-layer queueing may only be required when the end-hosts cannot predict the path of the packets they transmit and receive.

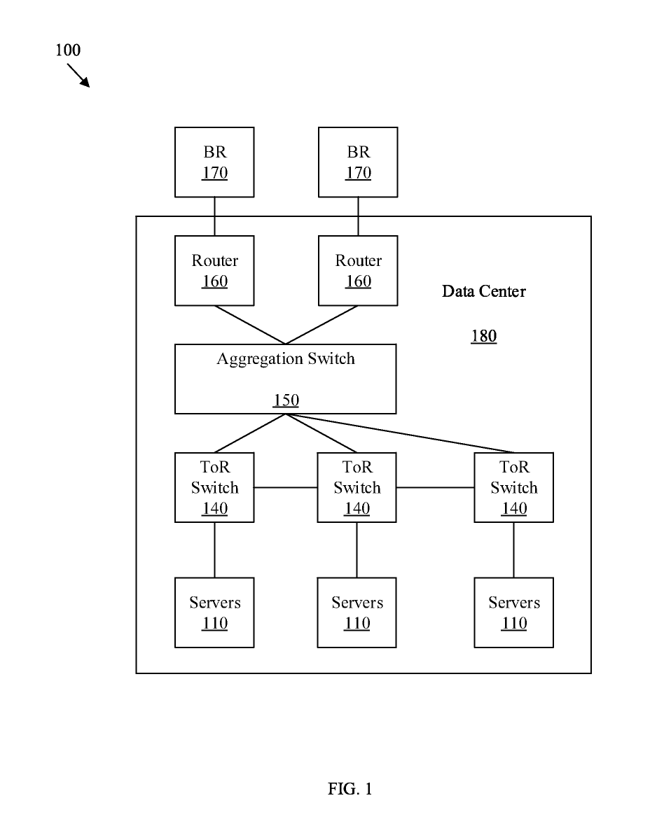

FIG. 1 is a schematic diagram of an embodiment of a multilayer data center network 100 architecture, which may be employed for priority selection. The network 100 may be positioned in a data center 180. The data center network 100 may comprise servers 110, which may operate hypervisors configured to operate virtual machines (VMs), containers, etc. The hypervisors may move VMs to other hypervisors and/or servers. The hypervisors may communicate with a management node in the network 100 to facilitate the transmission of the VMs and/or containers as well as perform associated routing. The servers 110 are connected via a plurality of Top-of-Rack (ToR) switches 140 and an aggregation switch 150 (e.g. and End of Row switch). The network 100 further comprises routers 160 and border routers (BR) 170 to manage traffic laving the data center network 100 domain.

A datacenter 180 may be a facility used to house computer systems and associated components, such as telecommunications and storage systems. The datacenter 180 may include redundant and/or backup power supplies, redundant data communications connections, environmental controls (e.g., air conditioning, fire suppression) and security devices. The datacenter 180 may comprise the datacenter network 100 to interconnect servers 110 and storage devices, manage communications, and provide remote hosts and/or local hosts access to datacenter 180 resources (e.g. via border routers 170.) A host may be any device configured to request a service (e.g. a process, storage, etc.) from a server 110. As such, servers 110 may be considered hosts.

A datacenter 180 may house a plurality of servers 110. A server 110 may be any device configured to host VMs and provide services to other hosts. A server 110 may provide services via VMs and/or containers. A VM may be a simulation and/or emulation of a physical machine that may be configured to respond to requests in a predetermined manner. For example, VMs may run a single program and/or process or may act as a system platform such as an operating system (OS). A container may be a virtual system configured to maintain a runtime environment for operating virtual functions. While VMs and containers are different data constructs, VMs and containers are used interchangeable herein for clarity of discussion. VMs may receive requests from hosts, provide data storage and/or retrieval, execute processes, and/or transmit data (e.g. process results) to the hosts. The VMs may be managed by hypervisors and may comprise a plurality of virtual interfaces, which may be used to communicate with hosts. Internet Protocol (IP) address(es) may be associated with a VM. The VMs and/or portions of VMs may be moved from server 110 to server 110 which may result in a short burst of traffic (e.g. a microburst) during transmission. Short bursts of traffic may also occur from data transfers between different VM's which are parts of the same application.

Servers 110 may be positioned in racks. Each rack may comprise a ToR switch 140, which may be a switch used to connect the servers 110 in a datacenter 180 to the datacenter network 100. The ToR switches 140 may be connected to each server in a rack as well as to other ToR switches 140 to allow communication between racks. Racks may be positioned in rows. The ToR switches 140 may be connected to aggregation switches 150, such as end-of-row (EoR) switches, which may allow communication between rows and may aggregate communications between the servers for interaction with the datacenter's 180 core network. The aggregation switches 150 may be connected to routers 160, which may be positioned inside the datacenter 180 core network. Communications may enter and leave the data center 180 via BRs 170. A BR may be the positioned at the border of the data center network 100 domain and may provide connectivity between VMs and remote hosts outside of the data center network communicating with local VMs (e.g. via the Internet.)

For purposes of the present disclosure, a multi-layer network may be any network that allows a plurality of paths to be provisioned dynamically between servers 110, while a single layer network is any network that is structured to consistently employ the same path between servers 110 for each communication. Data center network 100 is a multi-layer network because ToR switches 140 may determine to pass data traffic directly between themselves or via the aggregations switch 150. As such, data center network 100 may be an example of a network that may be employed to implement multilayer priority selection schemes as discussed hereinbelow.

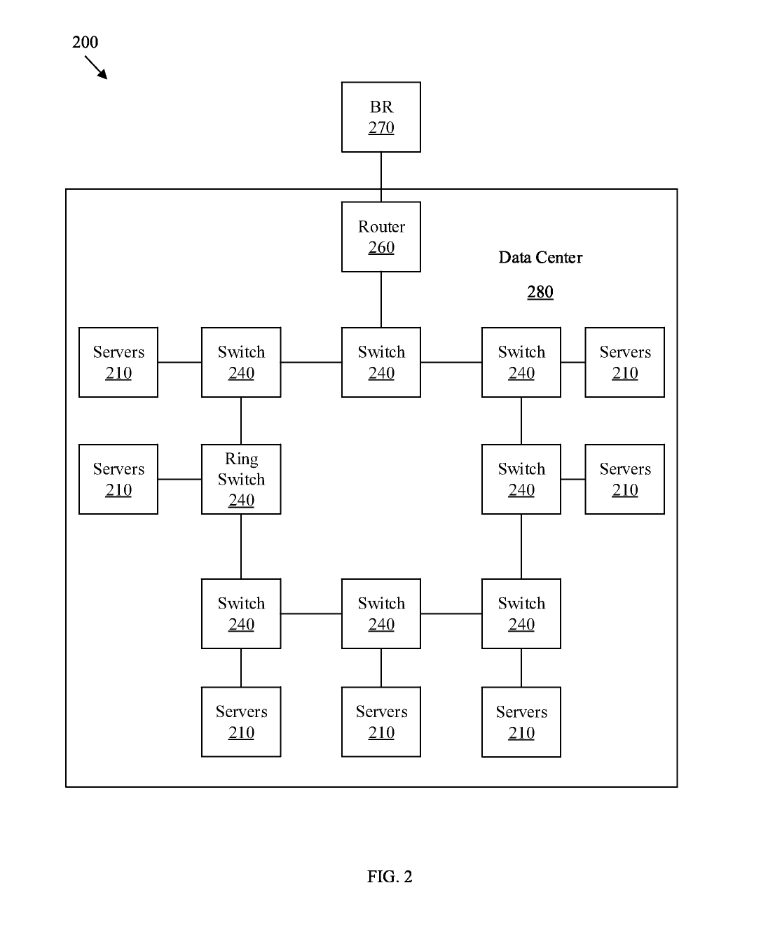

FIG. 2 is a schematic diagram of an embodiment of a single layer data center network 200 architecture. Network 200 may comprise similar components to network 100 in a different configuration. Network 200 is housed in a datacenter 280 and comprises servers 210, switches 240, router 260, and BR 270, which are substantially similar to datacenter 180, servers 210, TOR switches 140, router 160, and BR 170. Unlike network 100, the switches 240 of network 200 are configured in a ring structure. Shortest paths between servers 210 can be pre-determined prior to run-time based on a number of hops between servers 210 and are consequently substantially static. As such, each server 210 may consistently communicate with a corresponding server 210 via the same path. Accordingly, data center network 200 is an example of a network that may be employed to implement single layer priority schemes as discussed herein.

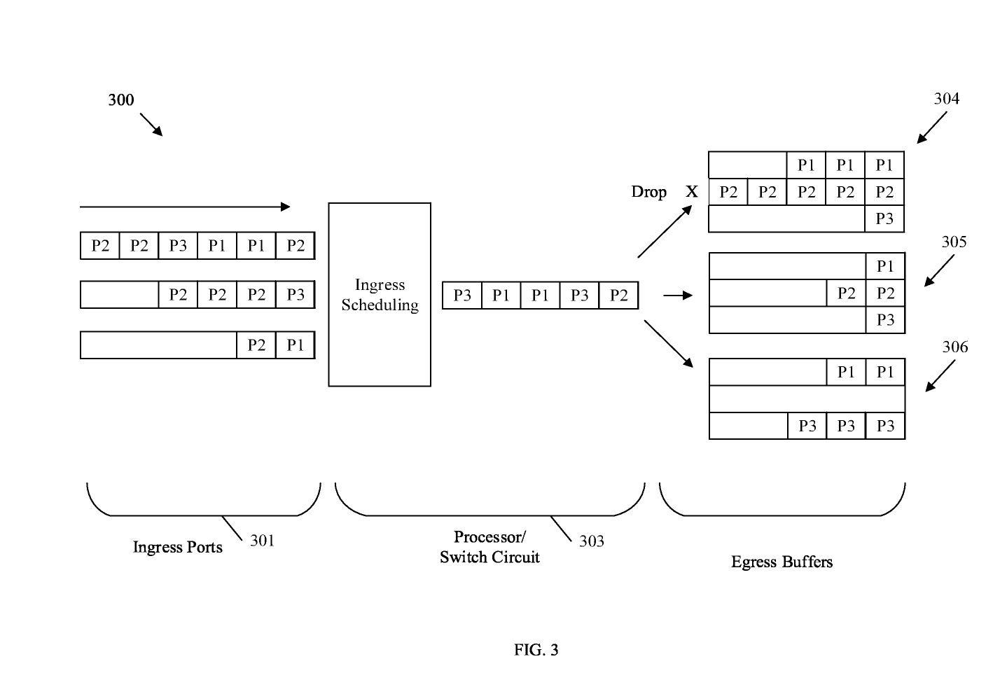

FIG. 3 is a schematic diagram of an embodiment 300 of a packet drop due to a congested priority queue. Embodiment 300 may occur on a ToR switch 140, an aggregation switch 150, and/or a switch 240, and similar issues may also occur on ingress ports of servers 110 and 210. A NE (e.g. switch, router, or sever) constantly receives packets on ingress ports 301. The packets are routed according to a plurality of priorities such as priority 1 (P1), priority 2 (P2), and priority 3 (P3). A processor or switch circuit 303 performs ingress scheduling on the packets based on packet priority and forwards them to egress buffers 304, 305, and 306 for storage until the packets can be forwarded across the network via corresponding output ports. Egress buffers 304, 305, and 306 may or may not be located in a shared memory space. As shown in egress buffer 304, a large amount of P2 traffic has been received and has filled the P2 queue of buffer 304. Additional P2 traffic must be dropped until additional space in the P2 queue of buffer 304 can be cleared by transmission of stored P2 packets. This occurs despite buffer 304 containing additional space in P1 and P3 and despite the fact that the port associated buffer 304 may not be particularly over utilized as evidenced by the availability of buffer space. P2 space in buffers 305 and 306 may not be used as buffers 305 and 306 are allocated for storing traffic being routed to other ports and/or along other paths. An excess of traffic of a particular priority type may occur due to a microburst, for example occurring when a VM is moved between servers. The entire VM may be transmitted employing the same priority, which overloads the associated queue in an associated buffer along a network path between the source and destination of the VM. This results in packet drops, in this case for P2 packets, for a short duration until the transfer is complete and traffic normalizes. As such, the problems associated with embodiment 300 may develop, cause packet drops, and normalize before traffic engineering protocols can detect the issue and take corrective action.

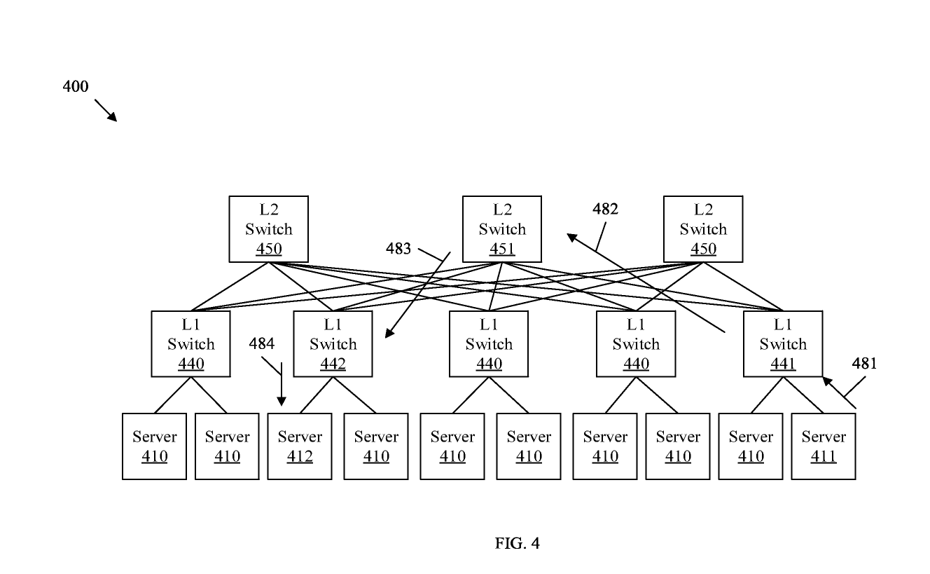

FIG. 4 is a schematic diagram of an embodiment of a scheme for communicating a queue occupancy counter across a network 400 domain, such as networks 100 and/or 200. Network 400 comprises servers 410, 411, and 412 and switches 440, 441, 442, 450, and 451, which may be similar to servers 110 and/or 210 and switches 140, 150, and/or 240, respectively. While network 400 is configured to support a significant variety of paths between hosts/servers, for purposes of explanation network 400 is assumed to be configured as a single layer network such that each servers (e.g. server 410, 411, and 412) always communicates with corresponding servers via the same path unless traffic engineering protocols require a path change. For purposes of the present example, server 411 communicates with server 412 via a path and a reverse path traversing switches 441, 451, and 442. A reverse path is a path that proceeds in the opposite direction of an initial path between two communicating servers/hosts. The reverse path may employ different ports, queues, and/or buffers than the path, but may traverse the same network nodes and links. The server 411 acts as a source and server 412 acts as a destination for a communication along the path. The server 411 acts as a destination and server 412 acts as a source for a communication along a reverse path in the opposite direction of the path. Server 411 transmits a packet comprising a header with a queue occupancy counter 481 along the path. The queue occupancy counter 481 contains congestion values for each priority queue on a server 411 port that could receive a message from server 412 along a reverse path. The switch 441 receives the packet traversing the path and updates the queue occupancy counter 481 with congestion values for each its local priority queues on its local ports along the reverse path from server 412 to server 411 resulting in a message with queue occupancy counter 482. Switch 451 updates queue occupancy counter 482 with congestion values for its ports along the reverse path resulting in queue occupancy counter 483 and forwards the packet along the path. Switch 442 then updates queue occupancy counter 482 with congestion values for its ports along the reverse path resulting in queue occupancy counter 484 and forwards the packet to server 412. As such, queue occupancy counter 484 contains an aggregate congestion value for each priority queue across all ports along a reverse path beginning at server 412 and ending at server 411. Accordingly, server 412 has the ability to review queue occupancy counter 484 and alter the priority for messages traversing the reverse path between server 412 and server 411 to avoid congested priority queues in real time. For example, server 412 can avoid the problem of embodiment 300 by changing the priority of messages traversing the reverse path from P2 to P3, resulting in the microburst begin distributed over multiple allowed priorities, greater utilization of the priority queue buffer, and avoidance of packet drops.

The servers 410, 411, and 412 may each comprise a priority matrix for storing values from queue occupancy counters. For example, a server 412 may comprise a priority matrix as follows prior to receiving queue occupancy counter 484:

TABLE 1

| | Priority P1 | Priority P2 | Priority P3 |
|---|---|---|---|
| 10.0.0.1 | 3 | 1 | 6 |
| 10.0.0.2 | 2 | 3 | 4 |
| 10.0.0.3 | 5 | 1 | 0 |
| 10.0.0.4 | 5 | 7 | 1 |

The servers 410 and 411 are denoted by IP address. For example, server 411 may comprise an IP address of 10.0.0.4. The queue occupancy counter 484 may comprise congestion values five, three, and six for P1, P2, and P3, respectively. Based on queue occupancy counter 484, the server 412 may update its priority matrix as follows:

TABLE 2

| | Priority P1 | Priority P2 | Priority P3 |
|---|---|---|---|
| 10.0.0.1 | 3 | 1 | 6 |
| 10.0.0.2 | 2 | 3 | 4 |
| 10.0.0.3 | 5 | 1 | 0 |
| 10.0.0.4 | 5 | 3 | 6 |

Based on the priority matrix, the server 412 may determine to send packet(s) along a reverse path to server 411 by employing P2 instead of P3 as the queue occupancy counter 484 has indicated that P2 is now the least congested priority queue.

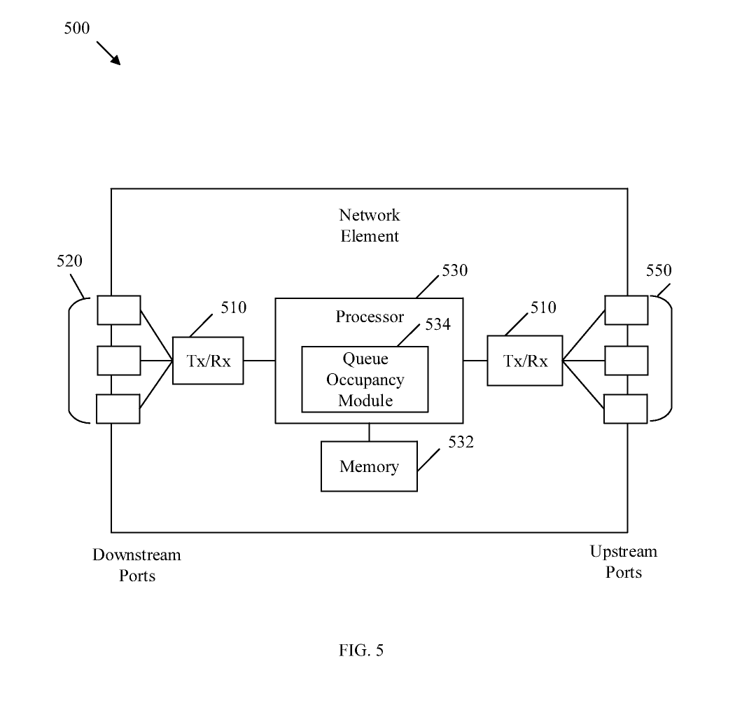

FIG. 5 is a schematic diagram of an embodiment of a network element (NE) within a network. For example, NE 500 may act as a server/host 110, 210, 410, 610, 810, 811, 812 and/or 910, a switch 140, 150, 240, 440, 450, 640, 740, 840, 841, 842, 850, 851, 940, a router 160, 170, 260, and/or 270, and/or any other node in networks 100, 200, 400, and/or 800. NE 500 may be implemented in a single node or the functionality of NE 500 may be implemented in a plurality of nodes. One skilled in the art will recognize that the term NE encompasses a broad range of devices of which NE 500 is merely an example. NE 500 is included for purposes of clarity of discussion, but is in no way meant to limit the application of the present disclosure to a particular NE embodiment or class of NE embodiments. At least some of the features/methods described in the disclosure are implemented in a network apparatus or component such as an NE 500. For instance, the features/methods in the disclosure may be implemented using hardware, firmware, and/or software installed to run on hardware. The NE 500 is any device that transports frames through a network, e.g., a switch, router, bridge, server, a client, host, etc. As shown in FIG. 5, the NE 500 may comprise transceivers (Tx/Rx) 510, which are transmitters, receivers, or combinations thereof. A Tx/Rx 510 is coupled to a plurality of downstream ports 520 (e.g. downstream interfaces) for transmitting and/or receiving frames from other nodes and a Tx/Rx 510 coupled to a plurality of upstream ports 550 (e.g. upstream interfaces) for transmitting and/or receiving frames from other nodes, respectively. A processor 530 is coupled to the Tx/Rxs 510 to process the frames and/or determine which nodes to send frames to. The processor 530 may comprise one or more multi-core processors and/or memory 532 devices, which function as data stores, buffers, Random Access Memory (RAM), Read Only Memory (ROM), etc. Processor 530 may be implemented as a general processor or may be part of one or more application specific integrated circuits (ASICs) and/or digital signal processors (DSPs). Processor 530 comprises a queue occupancy module 534, which implements at least some of the methods discussed herein such as schemes/embodiment/methods 600, 900, 1000, 1100, and/or 1200. In an alternative embodiment, the queue occupancy module 534 is implemented as instructions stored in memory 532, which are executed by processor 530, or implemented in part in the processor 530 and in part in the memory 532, for example a computer program product stored in a non-transitory memory that comprises instructions that are implemented by the processor 530. In another alternative embodiment, the queue occupancy module 534 is implemented on separate NEs. The downstream ports 520 and/or upstream ports 550 may contain electrical and/or optical transmitting and/or receiving components.

It is understood that by programming and/or loading executable instructions onto the NE 500, at least one of the processor 530, queue occupancy module 534, Tx/Rxs 510, memory 532, downstream ports 520, and/or upstream ports 550 are changed, transforming the NE 500 in part into a particular machine or apparatus, e.g., a multi-core forwarding architecture, having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an ASIC, because for large production runs the hardware implementation may be less expensive than the software implementation. Often a design is developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

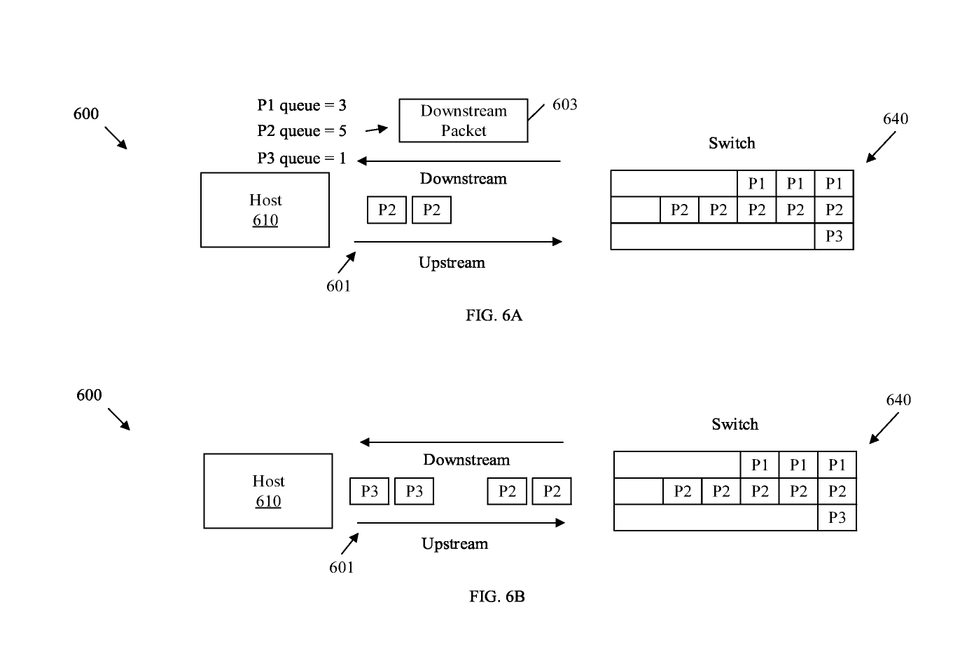

FIG. 6A is a schematic diagram of an embodiment 600 of a host 610 receiving a queue occupancy counter at a first time, for example from a switch 640 along a path. The host 610 and switch 640 may be substantially similar to servers 110, 210, and 410 and switches 140, 150, 240, 440, 441, 442, 450, and 451, respectively. Embodiment 600 is presented to further explain the use of the queue occupancy counter as discussed with respect to FIG. 4. Host 610 transmits packets to switch 640 in the upstream direction and receives packets from switch 640 in the downstream direction, where upstream is a direction toward the switch network and downstream is the direction toward the servers/hosts. Downstream packet 603 is transmitted from the switch 640 to the host 610 and carries a queue occupancy counter indicating the congestion values for each priority queue at switch 640 along the reverse path. Specifically, the congestion values for P1 queue is three, for the P2 queue is five, and the P3 queue is one. Meanwhile, host 610 is transmitting packets 601 along the reverse path by employing P2, which is congested at switch 640 (e.g. due to a microburst).

FIG. 6B is a schematic diagram of an embodiment 600 of a host 610 altering a priority selection at a second time based on the queue occupancy counter received at the first time. Specifically, host 610 reviews the queue occupancy counter of downstream packet 603 and determines that P3 is the least congested priority along the reverse path with a congestion value of one. Accordingly, host 610 begins sending all reverse path packets 601 by employing P3. It should be noted that packets related by a common session may be referred to as a flow. A burst of packets from the same flow is called a flowlet. The review of queue occupancy counter and priority switching discussed in embodiment 600 may occur for each packet, each flowlet, and/or each flow addition/modification. As discussed below, switching for each flowlet may balance the benefits of short granularity switching to manage microbursts and the processing overhead associated with constantly reviewing queue occupancy counters and performing switching.

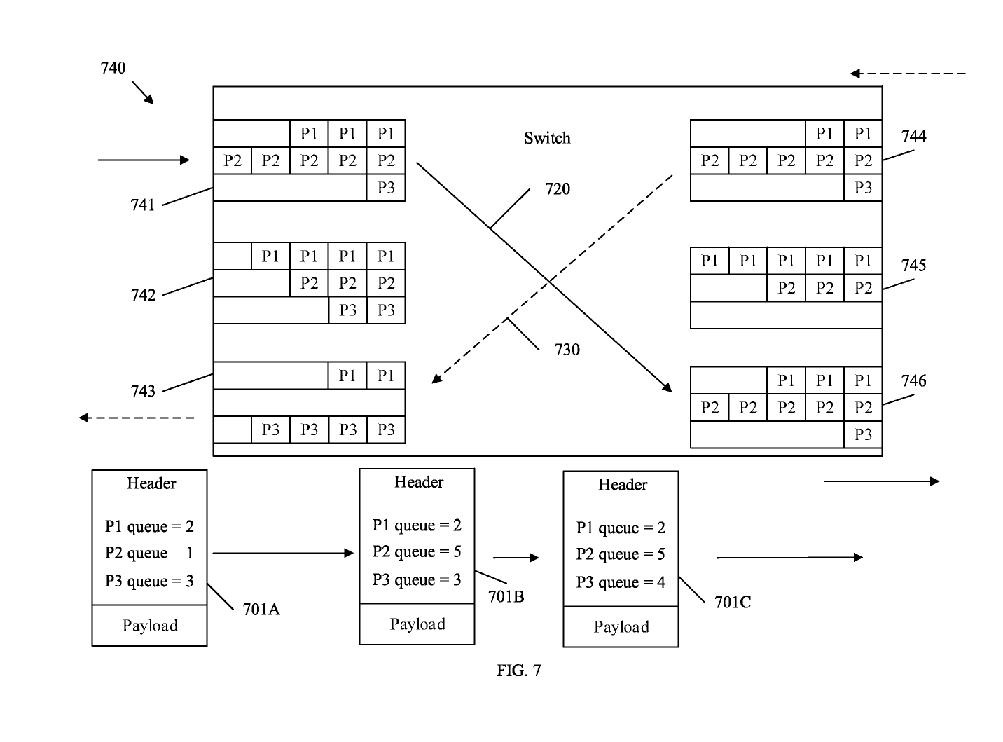

FIG. 7 is a schematic diagram of an embodiment of a switch 740 updating a queue occupancy counter 701A-C with priority congestion values for a reverse path 730. The switch 740 may be substantially similar to switches 140, 150, 240, 440, 450, 640, 840, 841, 842, 850, 851, and/or 940. The switch 740 comprises ports 741, 742, 743, 744, 745, and 746, each with a buffer for storing packets in priority queues. A packet comprising a payload and header with a queue occupancy counter 701A-C traverses a path through the switch via ports 741 and 746. A reverse path 730 for path 720 traverses the switch 740 via ports 743 and 744. The reverse path 730 is depicted as a dashed line while the path is depicted as a solid line for clarity of discussion. The queue occupancy counter 701A-C illustrates the congestion values of the priority queues along the reverse path 730 at varying times. At a first instance, the queue occupancy counter 701A indicates the congestion values of priority queues P1, P2, and P3 as two, one, and three respectively. The values of queue occupancy counter 701A are based on congestion values for other switches farther along the reverse path 730. The switch 740 receives the packet, determines the reverse path 730 for the path 720 and updates queue occupancy counter 701A with congestion values for the priority queues for ports 744 and 743. At a second instance, the queue occupancy counter 701 B is updated to include the congestion values of port 744. Specifically, port 744 priority queue for P2 has a congestion value of five, which is greater than the queue occupancy counter 701A P2 priority queue value of one. Accordingly, the maximum known congestion for the P2 queue along the reverse path is five so the value of queue occupancy counter 701B is set to five. The queue occupancy congestion values for P1 and P3 are two and one, respectively, and are less than or equal to the maximum known congestion for P1 and P3 queues, respectively, along the reverse path 730 and remain unchanged in queue occupancy counter 701B. At a third time instance, the switch 740 updates the queue occupancy counter 701B to include the congestion values of port 743 resulting in queue occupancy counter 701C. Specifically, the port 743 congestion value for P3 is four and is greater than the P3 congestion value in queue occupancy counter 701B, so queue occupancy counter 701C is updated with a congestion value for P3 of four. The P1 and P2 congestion values in queue occupancy counter 701B are greater than or equal to the corresponding congestion values for port 743 and are not changed. Accordingly, queue occupancy counter 701C contains the congestion values for each priority queue along the reverse path 730 including the values associated with ports 743 and 744. The queue occupancy counter 701C is then forwarded with the packet along the path 720 to support reverse path selection at the path destination/reverse path source (e.g. server/host). It should be noted that while FIG. 7 illustrates updating a queue occupancy counter 701A-C with maximum aggregate priority queue values, the queue occupancy counter 701A-C could also be updated based on other algorithms as would be understood by one of ordinary skill in the art, for example by employing aggregate average congestion values for each priority queue along the reverse path.

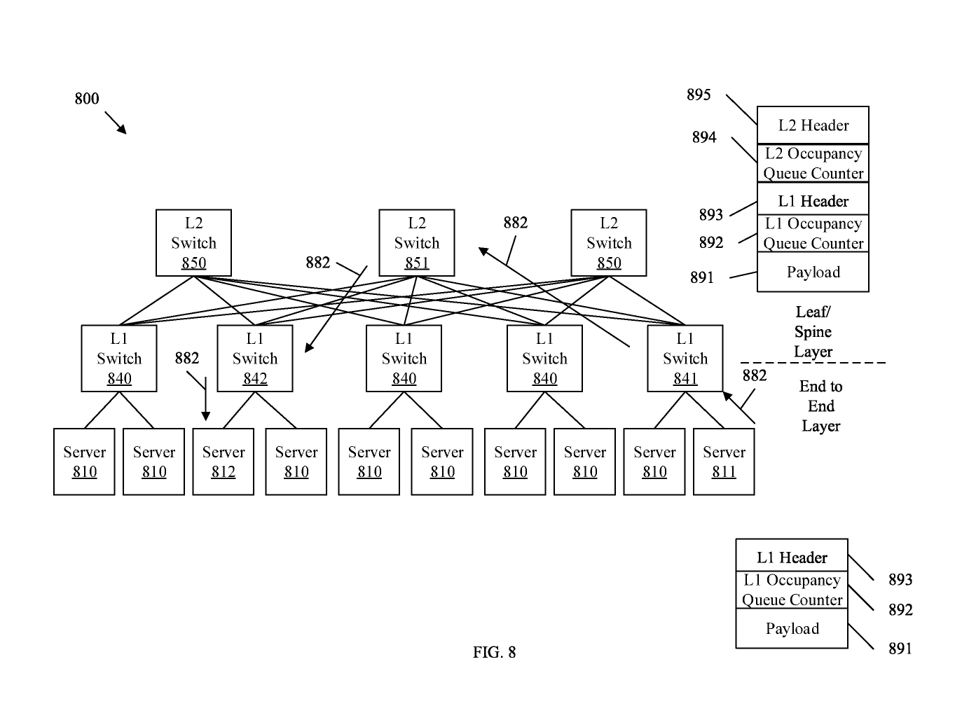

FIG. 8 is a schematic diagram of an embodiment of a mechanism for maintaining queue occupancy counters in a multilayer network 800 by employing encapsulation. As can be appreciated by reviewing the disclosure herein, the congestion values for a reverse path can only be gathered when the reverse path is known when the packet traverse the initial path. In multilayer networks the reverse path may dynamically change. Multilayer network 800 is presented to illustrate solutions for such a scenario. Multilayer network 800 is substantially similar to networks 100, 200, and 400, and comprises an end to end layer and leaf/spine layer. Communications traversing the end to end layer take essentially the same for each time, while paths through the leaf/spine layer may dynamically change based on network conditions. The network 400 comprises servers 810, 811, and 812, level one (L1) switches 840, 841, and 842, and level two (L2) switches, which may be substantially similar to servers/host 110, 210, 410, 610, and/or 910 and switches 140, 150, 240, 440, 450, 640, 740, and 940, respectively. An example path begins at server 811, traverses switches 841, 851, and 842, and ends at server 812. Upon receiving the packet along the path, the server 812 can be sure of the congestion values in the end to end layer, but cannot know the congestion values in the leaf/spine layer as the reverse path between switches 841 and 842 may change. Accordingly, servers 810, 811, and 812 each maintain local priority matrices for the end to end layer and switches 840, 841, and 842, and in some embodiments switches 850 and 851, each maintain local priority matrices for paths traversing the leaf/spine layer.

For example, a packet 822 leaving server 811 contains a payload 891 and a L1 header 893 comprising a L1 queue occupancy counter 892 with congestion values along the reverse path through the end to end layer. The L1 switch 841 updates the L1 queue occupancy counter 892 based on the congestion values on the L1 switch's 841 end to end layer interface as discussed above. The L1 switch 841 then chooses a path and a priority through the leaf/spine layer based on its local priority matrix. The L1 switch 841 then determines a reverse path through the leaf/spine layer based on the chosen path and encapsulates the packet 882 with a L2 header 895 that comprises a L2 queue occupancy counter 894. The encapsulation may be similar to a virtual extensible local area network (VXLAN) encapsulation. The L2 queue occupancy counter 894 is set based on congestion values for the reverse path through the leaf/spine layer. The packet 882 is then forwarded through L2 switch 851 and L1 switch 842. The L2 queue occupancy counter 894 is updated along the way with congestion values for the reverse path through the leaf/spine layer. The L1 switch 842 decapsulates the packet 882 and updates its local priority matrix with congestion values for the reverse path to L1 switch 841 through the leaf/spine layer based on the L2 queue occupancy counter 894. The L1 switch 842 then updates the L1 queue occupancy counter 892 based on the priority queue congestion in its end to end layer interface and forwards the packet to server 812. Server 812 then updates its local priority matrix based on the L1 queue occupancy counter 892. Accordingly, the server 812 is aware of congestion values for priority queues for the reverse path segments that traverse the end to end layer and can select priority for outgoing packets accordingly. The server 812 is not aware of the priority congestion in the leaf/spine layer. Further, the L1 switch 842 is aware of the priority congestion for the reverse path segments that traverse the leaf/spine layer. As such, the L1 switch 842 may select priorities for all paths traversing the leaf/spine layer for any packet the L1 switch receives for routing.

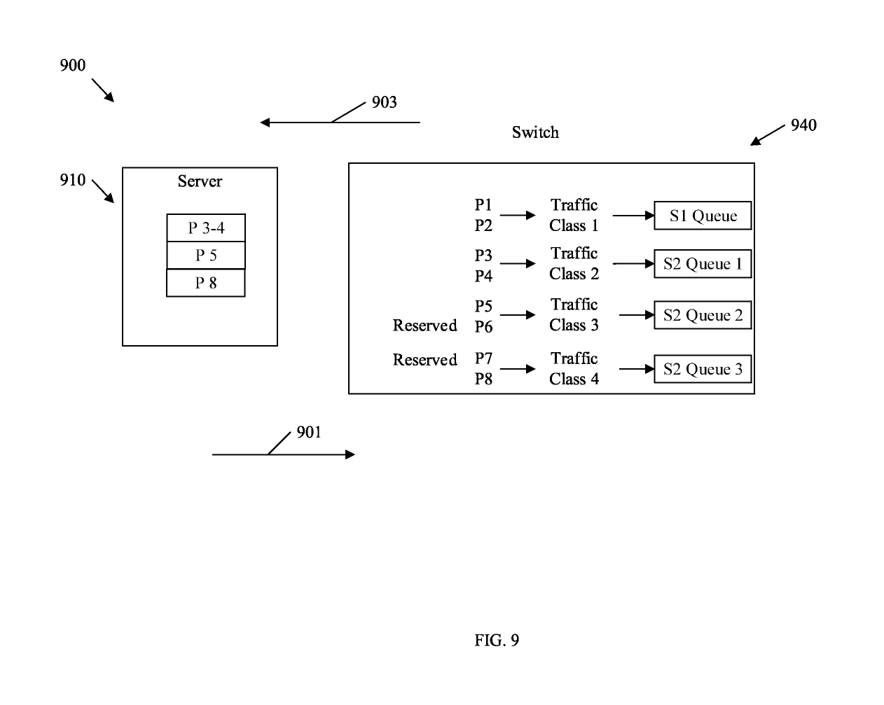

FIG. 9 is a schematic diagram of an embodiment 900 of a mechanism for mapping priorities to a queueing and scheduling structure of an end-host. Embodiment 900 may be employed in a network such as networks 100, 200, 400, and/800 on a server 910 and a switch 940, which may be substantially similar to servers servers/host 110, 210, 410, 610, 810 811, and/or 812 and switches 140, 150, 240, 440, 450, 640, 740, 840, 841, 842, 850 and/or 851, respectively. The switch 940 may send a downstream packet 903 with a queue occupancy counter indicating congestion values as discussed above. The switch 940 may comprises a scheme 1 (S1) queue and a scheme 2 (S2) queue, where S1 and S2 are different queueing schemes employed by the network. The switch 940 may comprise a P1 and P2 associated with traffic class 1, a P3 and P4 associated with traffic class 2, a P5 and a P6 associated with traffic class 3, and a P7 and a P8 associated with traffic class 4. Further, P6 and P7 may be reserved by the network for particular traffic. The traffic class correlations, queueing schemes, and the reserved status may be indicated to the server 910 in the queue occupancy counter and/or through other traffic engineering protocols.

The server 910 may determine to route a packet 901 along a reverse path based on the queue occupancy counter of packet 903 and/or its local priority matrix. The packet 903 may be associated with S2 and not S1, so the server 910 may remove P1 and P2 from consideration as eligible priority queues. The server 910 may also remove P6 and P7 from consideration as those priorities are reserved. The server 910 may merge all remaining priorities that share the same traffic class, resulting in P3-4, P5 and P8. The server 910 may then select an eligible priority group with the lowest combined aggregate congestion values for transmission of packet 901. As such, the server 910 may select the least congested allowable traffic class instead of selecting a specific priority. A priority may then be selected from the selected traffic class.

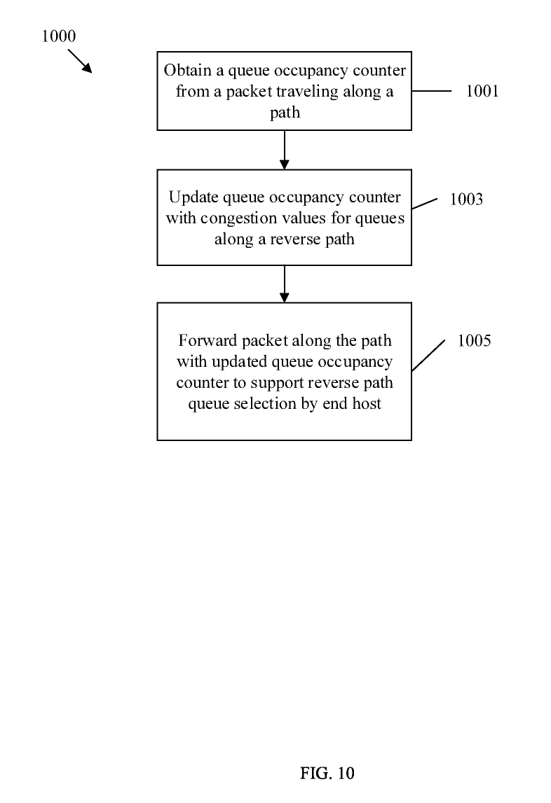

FIG. 10 is a flowchart of an embodiment of a method 1000 of updating a queue occupancy counter with priority congestion values for a reverse path, for example by a switch such as switches switch 140, 150, 240, 440, 450, 640, 740, 840, 841, 842, 850, 851, and/or 940. The method 1000 is initiated when a switch receives a packet with a queue occupancy counter. At step 1001, the queue occupancy counter is obtained from a packet traveling along a path. The queue occupancy counter contains congestion values for priority queues in remote nodes along a reverse path in an opposite direction of the path. For example, the queue occupancy counter may contain aggregate congestion values for priority queues of previous switches the packet has already traversed along the path. At step 1003, the queue occupancy counter is updated with congestion values for local priority queues along the reverse path. For example, the method 1000 may determine which local ports are positioned along the reverse path and update the queue occupancy counter to include congestion values for the priority queues for each determined port. At step 1005, the packet is forwarded along the path with the updated queue occupancy counter to support reverse path queue selection by an end host/server acting as a destination for the path and a source for the reverse path. For example, the packet is forwarded to the destination to carry a payload for the packet, but the queue occupancy counter traversing with the payload may be employed by the destination for reverse path selection for a return packet/communication which may or may not be related to the packet.

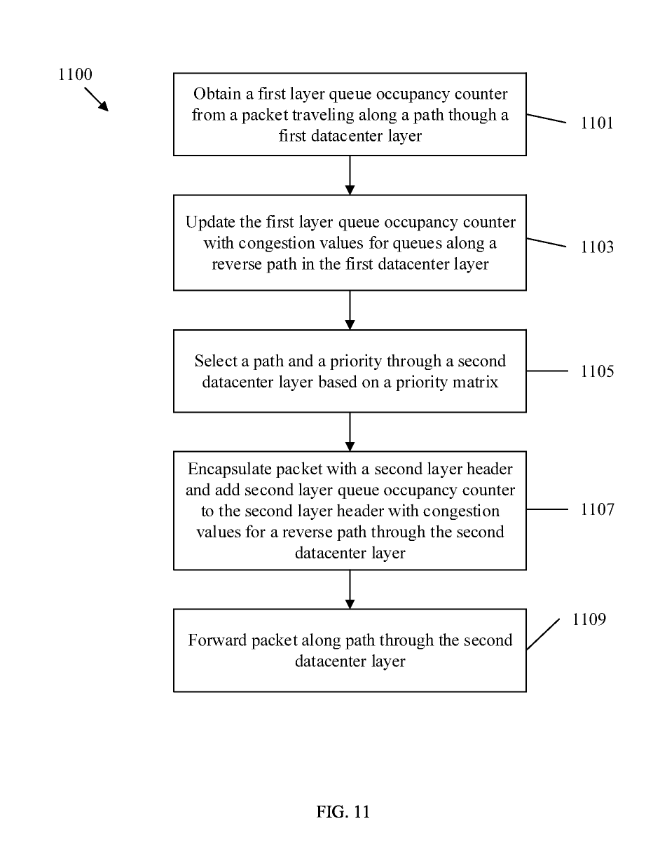

FIG. 11 is a flowchart of an embodiment of a method 1100 of maintaining queue occupancy counters in a multilayer network, for example by a switch such as switches 840, 841, 842, 850, and/or 851. Method 1100 is initiated when a switch in a multilayer network architecture receives a packet with a queue occupancy counter. At step 1101, a first layer queue occupancy counter is obtained from a packet traveling along a path through a first datacenter layer, for example as received by switch 841 in network 800. The queue occupancy counter contains congestion values for priority queues in remote nodes along a reverse path in an opposite direction of the path. At step 1103, the first layer queue occupancy counter is updated with congestion values for queues along a reverse path in the first datacenter layer. For example, the method 1100 may determine a local port interfacing the first datacenter layer along the reverse path and update the first layer queue occupancy counter with congestion values for priority queues of the determined port in the first data center layer (e.g. a downstream port). At step 1105, a path and a priority are selected through a second datacenter layer based on a priority matrix. At step 1107, the packet is encapsulated with a second layer header. A second layer queue occupancy counter is also added to the second layer header. The second layer queue occupancy counter comprises congestion values for a reverse path through the second datacenter layer. For example, the method 1100 may determine a local port interfacing the second datacenter layer along the reverse path through the second data center layer and set the second layer queue occupancy counter with congestion values for priority queues of the determined port in the second datacenter layer (e.g. an upstream port). At step 1109 the packet is forwarded along a path through the second datacenter layer to support reverse path priority queue selection in the first layer by a server employing the first layer queue occupancy counter and to support reverse path priority queue selection in the second layer by a switch employing the second layer queue occupancy counter.

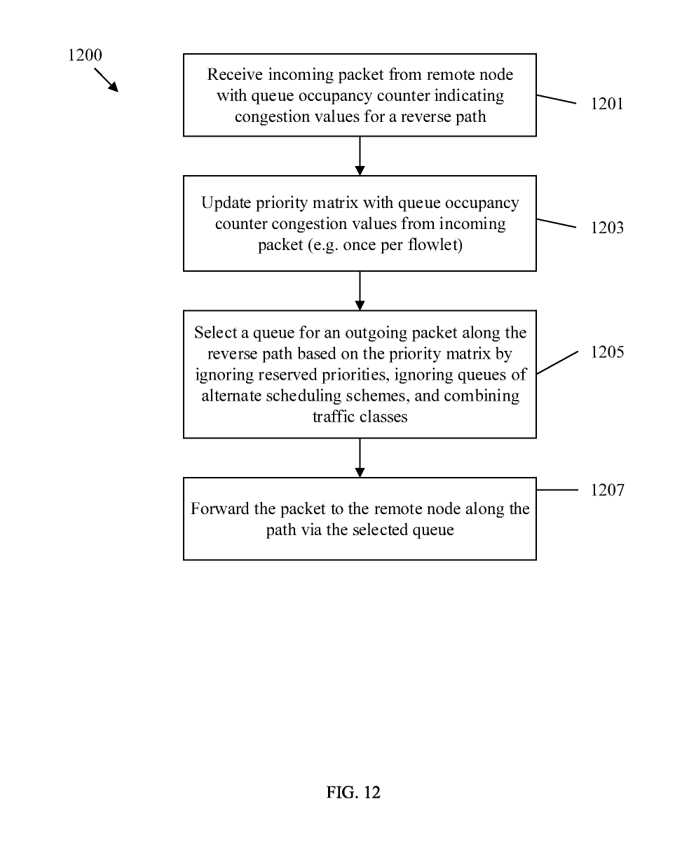

FIG. 12 is a flowchart of an embodiment of a method 1200 of priority selection based on a priority matrix, for example by a switch in a multilayer architecture such as switches 840, 841, 842, 850, and/or 851 and by a server such as servers/hosts 110, 210, 410, 610, 810, 811, 812 and/or 910. Method 1200 is initiated when a switch/server/host with a priority matrix receives an incoming packet/flowlet along a path. At step 1201, an incoming packet is received from a remote node with queue occupancy counter indicating congestion values for a reverse path. At step 1203, a local priority matrix is updated with queue occupancy counter congestion values from the incoming packet. For example, steps 1201 and 1203 may be performed once per flowlet, once per received packet, and/or once per new flow/flow modification depending on the embodiment and/or granularity desired. At step 1205, a priority queue is selected for an outgoing packet along the reverse path based on the priority matrix. The selection is performed by ignoring reserved priority queues and ignoring queues of alternate scheduling schemes to determine eligible priority queues and combining eligible priority queues based on traffic classes, for example as shown with respect to FIG. 9. The selection may include a selection of a traffic class with a lowest combined congestion value and a further selection of a priority queue with a lowest congestion value of the selected traffic class. At step 1207, the outgoing packet is forwarded to the remote node along the reverse path via the selected priority queue/traffic class.

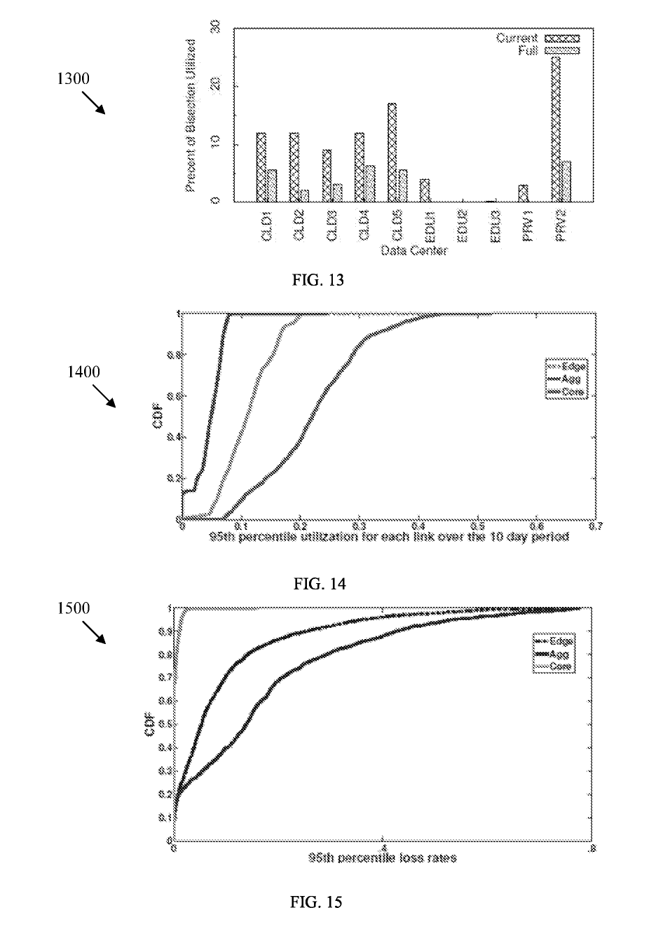

FIGS. 13 and 14 illustrate graphs 1300 and 1400 depicting link utilization and microbursts in an embodiment of a datacenter network, such as datacenter networks 100 and 200. Graph 1300 illustrates percent of bisection of links utilized versus various datacenter network links. As shown, typical full utilization remains between five and ten percent for most links. Further, current utilization represents packet bursts on the various links. As shown, even during burst condition, utilization for most links remains below thirty percent. Graph 1400 shows a Cumulative Distribution Function (CDF) indicating traffic distribution versus average ninety fifth percentile usage (e.g. full utilization) for edge nodes, aggregation nodes, and core nodes. Packet drops are likely to intensify as CDF approaches one.

FIG. 15 illustrates a graph 500 depicting packet loss in an embodiment of a datacenter network, such as datacenter networks 100 and 200. Graph 1500 shows a CDF for packet loss for high packet loss instances indicating microbursts. As shown, the CDF function of graph 1500 indicates that packet loss correlates more strongly with microbursts than with high link utilization.

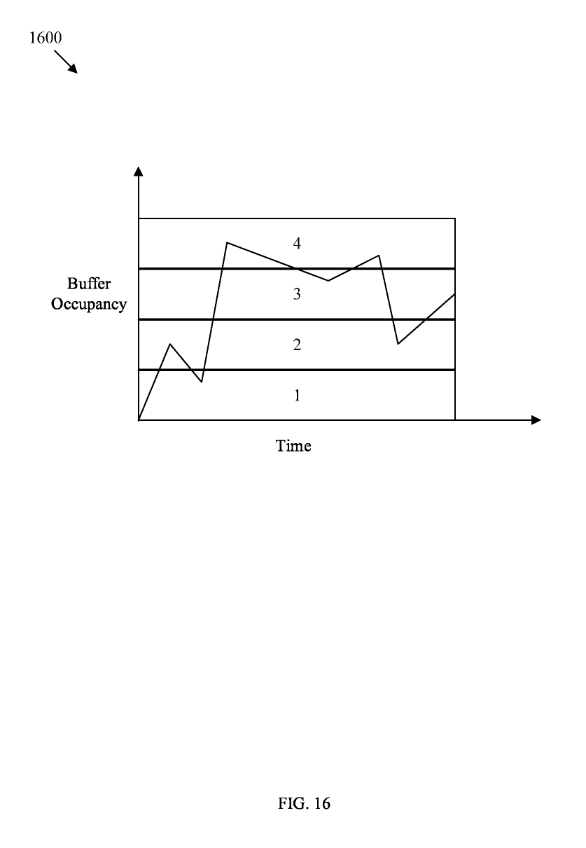

FIG. 16 is a graph 1600 of quartile buffer occupancy change over time and granularity of the buffer occupancy levels in an embodiment of datacenter network, such as networks 100, 200, 400, and 800. As shown, buffer occupancy changes rapidly and varies wildly over time. As such, granularity of priority matrix updates is important to effective priority queue selection for congestion avoidance. Priority matrix updates could be made per packet, per flowlet, and/or per new flow or flow routing change. Per packet significantly increases signaling overhead and processing, while per flow is too slow to react to the changes shown in graph 1600. As such, per flowlet may be an effective compromise between signaling overhead concerns and update speed. In addition, FIG. 16 shows the granularity of the buffer occupancy stats. Granularity may be selected to be high enough such that the buffer occupancy state generally remains constant while buffer occupancy information is delivered to the end node. However, granularity may also be set small enough to differentiate between different levels of buffer occupancies. In an example embodiment, four occupancy levels are defined, which can be employed to meet the forgoing criteria and be identified by only 2 bits.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

1. A network switch comprising:
a plurality of ports each comprising a plurality of queues; and
a processor coupled to the plurality of ports, the processor configured to:
obtain a packet traveling along a path from a source to a destination;
determine a reverse path port positioned along a reverse path from the destination to the source;
obtain a queue occupancy counter from the packet, the queue occupancy counter indicating an aggregate congestion of queues along the reverse path; and
update the queue occupancy counter with congestion data of the queues for the reverse path port.

2. The network switch of claim 1, wherein the processor is further configured to forward the packet with the updated queue occupancy counter along the path to support reverse path queue selection by the destination.

3. The network switch of claim 2, wherein the updated queue occupancy counter supports reverse path queue selection by providing an aggregate queue congestion for each eligible traffic class along the reverse path.

4. The network switch of claim 1, wherein the network switch is configured to forward a plurality of path flowlets along the path, and wherein updating the queue occupancy counter is performed as part of updating queue occupancy counters with congestion data for each flowlet.

5. The network switch of claim 1, wherein the queue occupancy counter comprises an aggregate congestion value for each queue along the reverse path, and wherein updating the queue occupancy counter with congestion data comprises setting the aggregate congestion value for a first of the queues to a maximum of a received aggregate congestion value for the first queue and a current congestion value for the first queue at each network switch port along the reverse path.

6. The network switch of claim 1, wherein the queue occupancy counter comprises an aggregate congestion value for each queue along the along the reverse path, and wherein updating the queue occupancy counter with congestion data comprises setting the aggregate congestion value of a first queue to a weighted average of congestion values of the first queue along the reverse path.

7. The network switch of claim 1, wherein determining the reverse path port is determined as part of determining a reverse path port pair positioned along the reverse path, and wherein updating the queue occupancy counter is performed as part of updating the queue occupancy counter with congestion data of the queues for the reverse path port pair.

8. The network switch of claim 1, wherein the processor is further configured to:
select a route for the path from the network switch to the destination;
determine a return port for a reverse path from the destination to the network switch based on the selected route for the path;
encapsulate the packet with a header comprising an upper layer queue occupancy counter, wherein the upper layer queue occupancy counter comprises a congestion value for each queue for the return port; and
forward the packet along the selected route for the path.

9. A method comprising:
receiving an incoming packet from a remote node along a path from the remote node;
obtaining a queue occupancy counter from the incoming packet, the queue occupancy counter indicating aggregate congestion values for each of a plurality of priority queues along a reverse path to the remote node; and
selecting an outgoing priority queue for an outgoing packet directed to the remote node along the reverse path by selecting a priority queue along the reverse path with a smallest aggregate congestion value from a group of eligible priority queues along the reverse path.

10. The method of claim 9, further comprising:
maintaining a priority matrix indicating available aggregate congestion values for each priority queue along a plurality of reverse paths to a plurality of destination nodes including the remote node; and
updating the priority matrix with the aggregate congestion values for the priority queues along the reverse path to the remote node,
wherein the outgoing priority queue is selected from the priority matrix.

11. The method of claim 10, wherein the incoming packet is one of a plurality of received flowlets, and wherein the aggregate congestion values are for each destination node are updated once per received flowlet associated with such destination node.

12. The method of claim 9, wherein selecting the outgoing priority queue comprises determining a group of eligible priority queues for selection by removing reserved reverse path priority queues from consideration.

13. The method of claim 9, wherein the outgoing packet is allocated for transmission based on a first scheduling scheme, wherein at least one of the reverse path priority queues employs a second scheduling scheme which is different from the first scheduling scheme, and wherein selecting the outgoing priority queue comprises determining a group of eligible priority queues for selection by removing reverse path priority queues employing the second scheduling scheme from consideration.

14. The method of claim 9, wherein selecting the outgoing priority queue comprises:
combining eligible priority queues with a common traffic class; and
selecting a traffic class with a lowest combined aggregate congestion value; and
selecting the priority queue along the reverse path with a smallest aggregate congestion value from the selected traffic class.

15. A method comprising:
obtaining a packet traveling along a path from a source to a destination;
determining a reverse path port positioned along a reverse path from the destination to the source;
obtaining a queue occupancy counter from the packet, the queue occupancy counter indicating an aggregate congestion of queues along the reverse path; and
updating the queue occupancy counter with congestion data of the queues for the reverse path port.

16. The method of claim 15, further comprising forwarding the packet with the updated queue occupancy counter along the path to support reverse path queue selection by the destination.

17. The method of claim 15, wherein the updated queue occupancy counter supports reverse path queue selection by providing an aggregate queue congestion for each eligible traffic class along the reverse path.

18. The method of claim 15, wherein the queue occupancy counter comprises an aggregate congestion value for each queue along the reverse path, and wherein updating the queue occupancy counter with congestion data comprises setting the aggregate congestion value for a first of the queues to a maximum of a received aggregate congestion value for the first queue and a current congestion value for the first queue at each network switch port along the reverse path.

19. The method of claim 15, wherein the queue occupancy counter comprises an aggregate congestion value for each queue along the along the reverse path, and wherein updating the queue occupancy counter with congestion data comprises setting the aggregate congestion value of a first queue to a weighted average of congestion values of the first queue along the reverse path.

20. The method of claim 15, further comprising:
selecting a route for the path from the network switch to the destination;
determining a return port for a reverse path from the destination to the network switch based on the selected route for the path;
encapsulating the packet with a header comprising an upper layer queue occupancy counter, wherein the upper layer queue occupancy counter comprises a congestion value for each queue for the return port; and
forwarding the packet along the selected route for the path.
